(19) United States
(12) Patent Application Publication
(10) Pub. No.: US 2025/0385996 A1
(43) Pub. Date: Dec. 18, 2025

(54) EVALUATION DEVICE AND DISPLAY DEVICE EVALUATION METHOD USING THE SAME

(71) Applicant: SAMSUNG DISPLAY CO., LTD., YONGIN-SI (KR)

(72) Inventors: Young Min PARK, Yongin-si (KR); Su Mi LEE, Yongin-si (KR)

(21) Appl. No.: 19/172,053

(22) Filed: Apr. 7, 2025

(30) Foreign Application Priority Data
Jun. 17, 2024 (KR) 10-2024-0078143
Aug. 28, 2024 (KR) 10-2024-0115866

(51) Int. Cl. H04N 13/133; H04N 13/00; H04N 13/204; H04N 13/302

(52) U.S. Cl. CPC H04N 13/133; H04N 13/204; H04N 2013/0074; H04N 13/302

(57) ABSTRACT

An evaluation device for evaluating a display device which displays images for viewpoints through a display panel, includes a first camera configured to photograph patterns for the viewpoints displayed by the display panel at coordinates arranged in the first direction, a second camera configured to capture reference images for the viewpoints displayed by the display panel at target measurement coordinates, and a controller configured to generate pattern measurement images from the patterns photographed by the first camera, determine the target measurement coordinates using luminance ratios of the pattern measurement images, and evaluate a crosstalk for at least one viewpoint of the viewpoints using luminance values of the reference images captured at the target measurement coordinates by the second camera.

### CROSS-REFERENCE TO RELATED APPLICATIONS

This application claims priority under 35 U.S.C. § 119 to Korean Patent Application No. 10-2024-0078143, filed on Jun. 17, 2024, and Korean patent application No. 10-2024-0115866, filed on Aug. 28, 2024, the entire disclosures of which are herein incorporated by reference in their entirety.

### BACKGROUND

### Technical Field

The present invention relates to an evaluation device and a display device evaluation method using the same.

### Discussion of Related Art

As information technologies develop, the importance of display devices, which are a connecting medium between users and information, is emerging. In response, the use of display devices such as liquid crystal display devices and organic light-emitting display devices is increasing.

Stereoscopic image display devices are display devices that may stimulate a visual sense of a viewer in the same way as in an actual object and may provide physical factors such that the viewer may perceive the object three-dimensionally. For example, stereoscopic image display devices may provide different images to left and right eyes of a viewer to enable the viewer to view a stereoscopic image through binocular parallax between the left eye and the right eye.

In stereoscopic image display devices, image quality may be evaluated through crosstalk. Crosstalk may refer to a phenomenon in which each of viewpoints overlaps an adjacent viewpoint(s). However, a conventional method of evaluating crosstalk, the crosstalk may be evaluated according to luminance measured for each angle from a center point.

### SUMMARY

Embodiments of the present invention are directed to providing an evaluation device having improved accuracy and a display device evaluation method using the same. For example, the evaluation device may improve the accuracy of the evaluation by determining target measurement coordinates using luminance ratios of pattern measurement images and evaluating crosstalk at the determined target measurement coordinates.

According to an embodiment of the present invention, an evaluation device for evaluating a display device which displays images for viewpoints through the display panel, includes a first camera configured to photograph patterns for the viewpoints displayed by the display panel at coordinates arranged in the first direction, a second camera configured to capture reference images for the viewpoints displayed by the display panel at target measurement coordinates, and a controller configured to generate pattern measurement images from the patterns photographed by the first camera, determine the target measurement coordinates using luminance ratios of the pattern measurement images, and evaluate a crosstalk for at least one viewpoint of the viewpoints using luminance values of the reference images captured at the target measurement coordinates by the second camera.

The evaluation device may further include a first jig configured to support the first camera and the second camera, and a second jig configured to support the display device, wherein the first camera is provided to move in a first direction and a direction opposite to the first direction relative to the second jig, and the second camera is provided to move in the first direction, the direction opposite to the first direction, a third direction perpendicular to the first direction, and a direction opposite to the third direction relative to the second jig.

The first jig may be configured to move the first camera and the second camera in the first direction, the direction opposite to the first direction, the third direction, and the direction opposite to the third direction.

The second jig may be configured to move the display device in the first direction and the direction opposite to the first direction.

The patterns may be displayed to overlap a first line spaced apart from a center point of a reference line in a direction opposite to the first direction and a second line spaced apart from the center point in the first direction, wherein the reference line extends in the first direction on the display panel.

The patterns may include a first pattern and a second pattern displayed to overlap the first line and a third pattern and a fourth pattern displayed to overlap the second line, the first pattern and the second pattern may face each other with the reference line interposed therebetween, and the third pattern and the fourth pattern may face each other with the reference line interposed therebetween.

The patterns may be positioned adjacent to the reference line, the first pattern and the third pattern may be spaced apart from the reference line in a second direction intersecting the first direction, and the second pattern and the fourth pattern may be spaced apart from the reference line in the direction opposite to the second direction.

The first line and the second line may extend in the second direction and a direction opposite to the second direction from a first point corresponding to 1/10 and a second point corresponding to 9/10 when the reference line is divided into ten equal parts in the first direction, wherein the pattern measurement images may include a first pattern measurement image and a second pattern measurement image generated from the first pattern and the second pattern and a third pattern measurement image and a fourth pattern measurement image generated from the third pattern and the fourth pattern, and the controller may determine first measurement coordinates at which a luminance ratio of the second pattern measurement image to the first pattern measurement image may be a low value, second measurement coordinates at which a luminance ratio of the fourth pattern measurement image to the third pattern measurement image may be a low value, third measurement coordinates at which a luminance ratio of the first pattern measurement image to the second pattern measurement image may be a low value, and fourth measurement coordinates at which a luminance ratio of the third pattern measurement image to the fourth pattern measurement image may be a low value.

The controller may determine a point, at which a first virtual line extending from the first point to the third measurement coordinates overlaps a second virtual line extending from the second point to the fourth measurement coordinates, as the target measurement coordinates for a first viewpoint of the viewpoints.

The controller may determine a point, at which a third virtual line extending from the first point to the first measurement coordinates overlaps a fourth virtual line extending from the second point to the second measurement coordinates, as the target measurement coordinates for a second viewpoint of the viewpoints.

The display panel may include pixels, the pixels may include a first pixel group of the display device configured to display a stereoscopic image and a second pixel group configured to display the stereoscopic image, and the reference images may be displayed through the first pixel group and the second pixel group.

The reference images may include a first reference image corresponding to a first viewpoint of the viewpoints, a second reference image corresponding to a second viewpoint of the viewpoints, and a third reference image commonly corresponding to the first viewpoint and the second viewpoint, the first reference image may be configured to display a white gradation through the first pixel group and a black gradation through the second pixel group, the second reference image may be configured to display the black gradation through the first pixel group and the white gradation through the second pixel group, and the third reference image may be configured to display the black gradation through the first and second pixel groups.

The controller may calculate a first corrected luminance value by subtracting a third luminance value measured from the third reference image from a first luminance value measured from the first reference image, and a second corrected luminance value by subtracting the third luminance value measured from the third reference image from a second luminance value measured from the second reference image, and the controller may evaluate the crosstalk for the first viewpoint using a ratio of the second corrected luminance value to the first corrected luminance value.

The controller may be configured to evaluate uniformity for the at least one viewpoint.

According to an embodiment of the present invention, an evaluation device for evaluating a display device which displays images for viewpoints through a display panel includes a camera having a first mode configured to photograph patterns for the viewpoints displayed by the display panel at coordinates arranged in a first direction and a second mode configured to capture reference images for the viewpoints displayed by the display panel at target measurement coordinates, and a controller configured to generate pattern measurement images from the patterns photographed by the camera in the first mode, determine the target measurement coordinates using luminance ratios of the pattern measurement images, and evaluate crosstalk for at least one viewpoint of the viewpoints using luminance values of the reference images captured at the target measurement coordinates by the camera in the second mode.

According to an embodiment of the present invention, a display device evaluation method of evaluating a display device including a display panel, the display device evaluation method includes displaying, by the display panel, patterns for viewpoints, photographing the patterns at coordinates disposed along a first direction, determining target measurement coordinates for at least one viewpoint of the viewpoints based on the patterns, outputting reference images for the viewpoints, capturing the reference images at the target measurement coordinates, and evaluating a crosstalk for the at least one viewpoint using luminance values of the reference images.

The determining of the target measurement coordinates may include generating pattern measurement images from the patterns and determining measurement coordinates using luminance ratios of the pattern measurement images, and determining the target measurement coordinates using virtual lines extending from the patterns to the measurement coordinates.

At the target measurement coordinates, a crosstalk for at least one viewpoint of the viewpoints may have a minimum value.

The photographing of the patterns may be performed using a first camera, and the capturing of the reference images may be performed using a second camera.

Determining the target measurement coordinates for the at least one viewpoint of the viewpoints based on the patterns may include determining a number of the target measurement coordinates to be determined using luminance ratios of the pattern measurement images.

### BRIEF DESCRIPTION OF THE DRAWINGS

Illustrative, non-limiting embodiments will be more clearly understood from the following

detailed description in conjunction with the accompanying drawings.

FIG. 1 is a view illustrating a display device according to an embodiment of the present invention.

FIG. 2 is a view illustrating an evaluation device according to an embodiment of the present invention.

FIG. 3 is a plan view illustrating an embodiment of the display device of FIG. 1.

FIG. 4 is a block diagram illustrating an embodiment of a controller of the evaluation device of FIG. 2.

FIG. 5 is a flowchart illustrating a display device evaluation method according to an embodiment of the present invention.

FIG. 6 is a view illustrating an example of patterns output on the display device of FIG. 3.

FIG. 7 is a view illustrating an example in which a first camera of the evaluation device of FIG. 2 photographs patterns.

FIG. 8 is a view illustrating an example in which a controller of the evaluation device of FIG. 2 determines measurement coordinates from pattern measurement images.

FIG. 9 is a view illustrating an example in which the controller of the evaluation device of FIG. 2 determines target measurement coordinates.

FIG. 10 is a view illustrating an example in which a second camera of the evaluation device of FIG. 2 captures reference images.

FIG. 11 is a view illustrating an example of the reference images captured in FIG. 10.

FIG. 12 is a view illustrating an example of a crosstalk evaluated by the evaluation device of FIG. 2.

FIG. 13 is a view illustrating an example of uniformity analyzed using the crosstalk of FIG. 12.

### DETAILED DESCRIPTION

Hereinafter, embodiments of the present invention will be described in detail with reference to the accompanying drawings. In the following description, it should be noted that portions required for comprehension of operations according to the present invention will be described and descriptions of other portions may be omitted or simplified. In addition, the present invention is not limited to example embodiments but may also be embodied in other forms. Rather, embodiments are provided so that the present invention will be thorough, and complete, and will fully convey the present invention to those skilled in the art.

Throughout the specification, it will be understood that when an element is referred to as being “coupled” or “connected” to another element, it can be directly coupled or connected to the other element or intervening elements may be present therebetween. The terminology used herein is for the purpose of describing specific embodiments and is not intended to limit the present invention. Throughout the specification, unless explicitly described to the contrary, the word “comprise” and variations such as “comprises” or “comprising” will be understood to imply the inclusion of stated elements but not the exclusion of any other elements. “At least any one of X, Y, and Z” and “at least any one selected from the group consisting of X, Y, and Z” may be construed as each of X, Y, and Z or a combination of two or more of X, Y, and Z (for example, XYZ, XYY, YZ, and ZZ). As used herein, “and/or” includes one or more combinations of corresponding components.

It will be understood that, although the terms “first”, “second”, “third”, and so on may be used herein to describe various elements, these elements are not limited by these terms. These terms are used to distinguish elements. Thus, a first element described herein could also be termed as a second or third element without departing from the spirit and scope of the present invention.

Aspects of the present disclosure provide a display device that can detect and analyze crosstalk that may result in a mixed image at each viewpoint. In an evaluation device for evaluating a display device that displays images for viewpoints according to embodiments of the present invention, an accuracy of evaluation may be improved by determining target measurement coordinates corresponding to a left eye viewpoint and a right eye viewpoint in advance, and crosstalk of the display device at the determined target measurement coordinates may be evaluated. In addition, an evaluation device may reduce an evaluation time of a crosstalk by measuring a luminance value with a number of shots at target measurement coordinates.

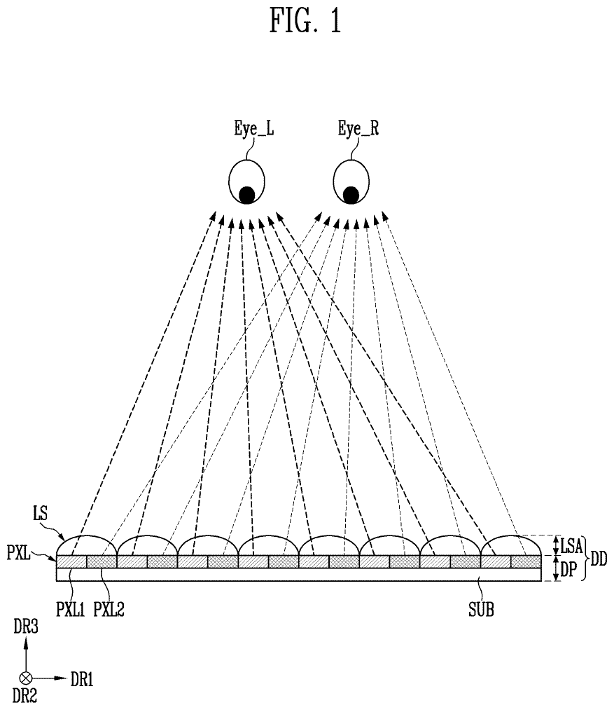

FIG. 1 is a view illustrating a display device according to an embodiment of the present invention.

Referring to FIG. 1, a display device DD may include a display panel DP and a lens array LSA.

The display panel DP may include pixels PXL configured to emit light to display an image. In an embodiment, each of the pixels PXL may output light of a first color (for example, a red color), light of a second color (for example, a green color), or light of a third color (for example, a blue color). However, this is merely an example, and a color of light emitted from pixels PXL is not limited thereto, and light of various colors may be output for full-color implementation.

The display panel DP may include an organic light-emitting display panel, a liquid crystal display Panel, or a quantum Dot display panel. The display panel DP may include other types of panels, and embodiments are not particularly limited by the display panel DP type.

The lens array LSA may be disposed on the display panel DP. The lens array LSA may include lenses LS. The lenses LS may refract light incident from pixels PXL. For example, the lens array LSA may be implemented as a lenticular lens array or a micro lens array.

When the lens array LSA is formed on the display panel DP, a series of pixels PXL may be correspond to each lens LS, and light from each of the pixels PXL may be refracted by the lenses LS to travel in a specific direction. As an example, the display panel DP may display a left eye image and a right eye image at positions respectively corresponding to each of the lenses LS. In this case, the lenses LS may focus the left eye image and the right eye image displayed on the display panel DP such that a left eye Eye_L and a right eye Eye_R of a user may separately perceive the left eye image and the right eye image.

For example, when a lens LS may be disposed overlapping a first pixel PXL1 and a second pixel PXL2, the first pixel PXL1 may display the left eye image, and the second pixel PXL2 may display the right eye image. The left eye image displayed by the first pixel PXL1 may be viewed to the left eye Eye_L of the user through the lens LS, and the right eye image displayed by the second pixel PXL2 may be viewed to the right eye Eye_R of the user through the lens LS. Thus, the user may perceive an image viewed from the display device DD as a three-dimensional (3D) image due to a binocular disparity of the left eye image and the right eye image.

According to an embodiment, a light field display may be a three-dimensional (3D) display device, which may form a light field expressed as a vector distribution (intensity, direction) of light in a space using a flat display and optical elements (for example, the lens array LSA), which may implement a stereoscopic image. The light field display may be a display technology that may be used in a variety of ways through convergence with an augmented reality (AR) technology in which the display technology allows the depth and side surfaces of an object to be perceived, which may achieve improved stereoscopic images. For example, the stereoscopic images may have a more natural appearance.

A light field may be implemented through various methods. For example, the light field may be generated through a method of generating a light field in a plurality of directions using a plurality of projectors, a method of controlling the direction of light using a diffraction grating, a method of controlling the direction and intensity (luminance) of light according to a combination of each pixel using two or more panels, a method of controlling the direction of light using a pinhole or barrier, or a method of controlling the direction of refraction of light through the lens array LSA.

Meanwhile, the display device DD may be applied to any electronic device such as a smartphone, a television, a tablet personnel computer (PC), a mobile phone, a video phone, an e-book reader, a desktop PC, a laptop PC, a netbook computer, a workstation, a server, a personal digital assistant (PDA), a portable multimedia player (PMP), an MP3 player, a medical device, a camera, or a wearable device.

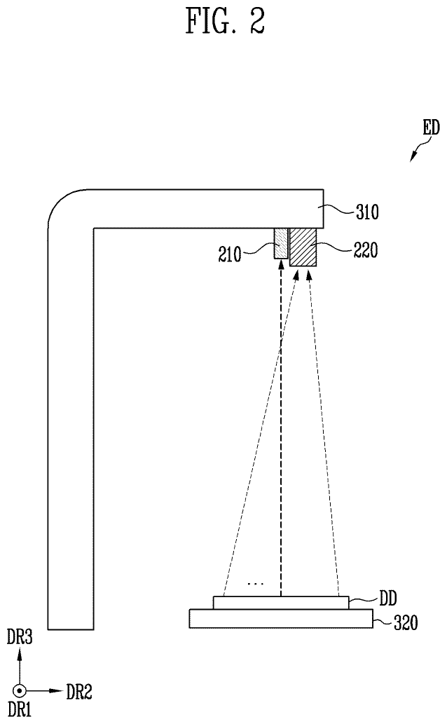

FIG. 2 is a view illustrating an evaluation device according to an embodiment of the present invention.

Referring to FIG. 2, an evaluation device ED according to an embodiment of the present invention may include a first camera 210, a second camera 220, a first jig 310, and a second jig 320.

The evaluation device ED may evaluate a crosstalk caused by a display device DD. The evaluation device ED may evaluate the display device DD that displays images for viewpoints through a display panel DP (see FIG. 1) extending in a first direction DR1 and a second direction DR2 intersecting the first direction DR1.

The first direction DR1 and the second direction DR2 may be disposed perpendicular to each other and may form a plane. A third direction DR3 may be disposed perpendicular to the plane formed by the first direction DR1 and the second direction DR2.

The viewpoints of the display device DD may be preset as positions for viewing an image displayed on the display panel DP. For example, the viewpoints may be set as coordinates corresponding to a right eye viewpoint and a left eye viewpoint of a user viewing an image of the display panel DP.

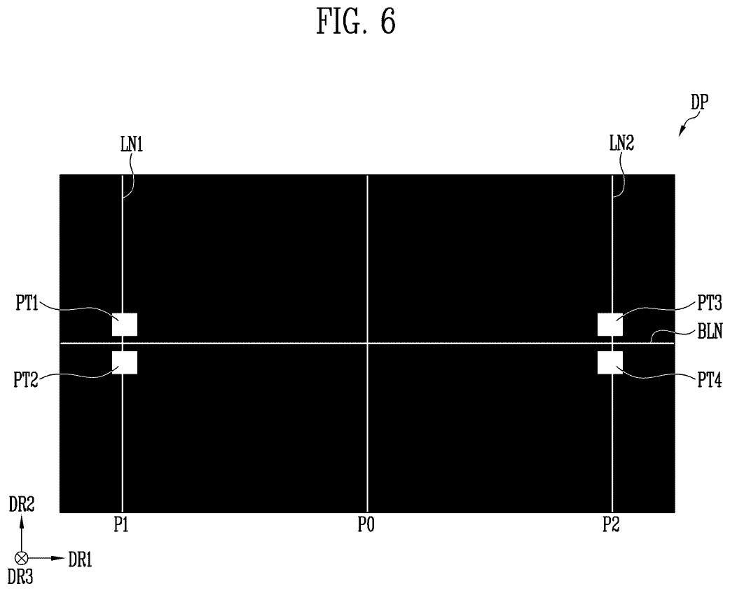

The first camera 210 may capture an image of a first pattern PT1, a second pattern PT2, a third pattern PR3, and a fourth pattern PT4 (see FIG. 6) displayed by the display panel DP. According to an embodiment, the first camera 210 may be a machine vision camera, but is not necessarily limited thereto. For example, a camera that may recognize patterns displayed by the display panel DP may be used.

The first camera 210 may be dispose above the display device DD. The first camera 210 may be move in the first direction DR1 and a direction opposite to the first direction DR1. The first camera 210 may photograph the first to fourth patterns PT1 to PT4 at coordinates along the first direction DR1. The first camera 210 may photograph the first to fourth patterns PT1 to PT4 at coordinates along the first direction DR1 by stopping at the coordinates along the first direction DR1 or while moving along the coordinates along the first direction DR1.

The second camera 220 may capture reference images displayed by the display panel DP. According to an embodiment, the second camera 220 may be a spectroradiometer or a multi-spectral camera, but is not necessarily limited thereto. For example, the second camera 220 may be a camera configured to measure the luminance of images displayed by the display panel DP.

The second camera 220 may be disposed above the display device DD. The second camera 220 may be disposed adjacent to the first camera 210. The second camera 220 may move in the first direction DR1 and the direction opposite to the first direction DR1. In addition, the second camera 220 may move in a third direction DR3 and a direction opposite to the third direction DR3. Accordingly, the second camera 220 may move to target measurement coordinates and capture reference images. The second camera 220 may capture reference images while stopped at each of the target measurement coordinates or may capture reference images while moving between each of the target measurement coordinates.

The first camera 210 may be mounted on a rail and may be connected to a stepper motor. For example, the stepper motor may move the first camera 210 along the rail in the first direction DR1 and the direction opposite to the first direction DR1. One of ordinary skill in the art would appreciate that the first camera 210 may be variously configured for movement. Accordingly, a position of the first camera 210 may be changed.

The second camera 220 may be mounted to move along two dimensions. For example, the second camera 220 may move in the first direction DR1 and the direction opposite to the first direction DR1, and may move in the third direction DR3 and the direction opposite to the third direction DR3. For example, the second camera 220 may be mounted on a screw type stepper motor, which may move the second camera 220 in the third direction DR3 and the direction opposite to the third direction DR3. The screw type stepper motor may be mounted on a rail and may be connected to a second stepper motor that may move the second camera 220 and the screw type stepper motor in the first direction DR1 and the direction opposite to the first direction DR1. One of ordinary skill in the art would appreciate that the second camera 220 may be variously configured for movement. Accordingly, a position of the second camera 220 may be changed.

The first jig 310 may support the first camera 210 and the second camera 220. The first jig 310 may be connected to the first camera 210 and the second camera 220. For example, the first camera 210 and the second camera 220 may be installed at an end portion of the first jig 310 and fixed at a position spaced apart from the display device DD in the third direction DR3.

The first jig 310 may move the first camera 210 and the second camera 220 in the first direction DR1, the direction opposite to the first direction DR1, the second direction DR2, and a direction opposite to the second direction DR2. In addition, the first jig 310 may move the first camera 210 and the second camera 220 in the third direction DR3 and the direction opposite to the third direction DR3. Accordingly, the positions of the first camera 210 and the second camera 220 may be changed. For example, the first jig 310 may move the first camera 210 along coordinates arranged in the first direction DR1. The first jig 310 may move the second camera 220 to target measurement coordinates.

The first jig 310 may connected to one or more stepper motors for moving the jig. For example, a stepper motor may move the first jig 310, the first camera 210 and the second camera 220 in the first direction DR1, the direction opposite to the first direction DR1, the second direction DR2, and the direction opposite to the second direction DR2. In addition, a stepper motor may move the first jig 310, the first camera 210 and the second camera 220 in the third direction DR3 and the direction opposite to the third direction DR3. One of ordinary skill in the art would appreciate that the first jig 310 may be variously configured for movement. Accordingly, positions of the first camera 210 and the second camera 220 mounted on the first jog 310 may be changed.

The second jig 320 may support the display device DD. The second jig 320 may mount the display device DD on the second jig 320 to face the first and second cameras 210 and 220.

The second jig 320 may move the display device DD. For example, the second jig 320 may move the display device DD in the first direction DR1 and the direction opposite to the first direction DR1. For example, the first camera 210 may have a fixed position, and the display device DD may be moved in the first direction DR1 and the direction opposite to the first direction DR1 by the second jig 320. Therefore, the first camera 210 may photograph the first to fourth patterns PT1 to PT4 at coordinates arranged in the first direction DR1.

The second jig 320 may move the display device DD in the second direction DR2, and the direction opposite to the second direction DR2. The second jig 320 may move the display device DD in the third direction DR3 and the direction opposite to the third direction DR3.

As described herein, positions of the first camera 210, the second cameras 220, and the second jig 320 may be variously moved relative to each other. In some examples the second jig 320 may have a fixed position. In some example, the first camera 210, the second cameras 220 may have fixed positions.

The first camera 210 and the second cameras 220 may be implemented as a same camera having a plurality of modes. For example, a camera may have a first mode for photographing the patterns and a second mode for capturing the reference images. In the first mode, the camera may be moved in the first direction and the direction opposite to the first direction relative to the second jig. In the second mode, the camera may be moved in the first direction and the direction opposite to the first direction relative to the second jig and in the third direction DR3 and the direction opposite to the third direction DR3.

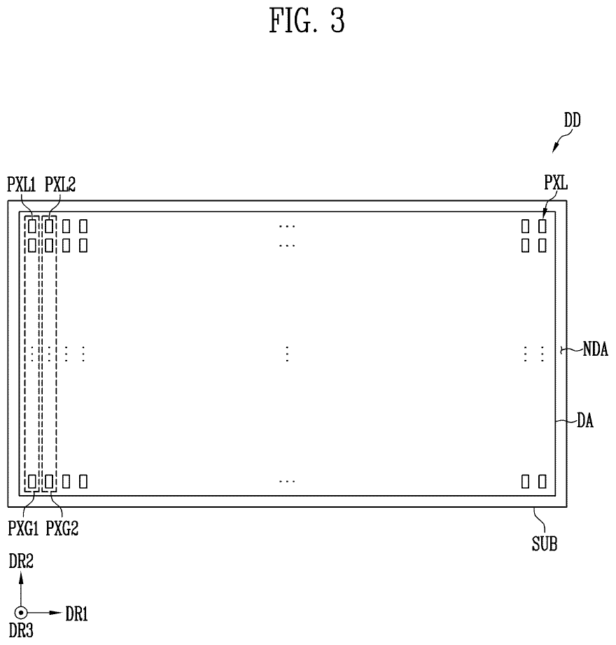

FIG. 3 is a plan view illustrating an embodiment of the display device of FIG. 1.

Referring to FIG. 3, a display device DD may include a substrate SUB and pixels PXL.

The substrate SUB may extend in a first direction DR1 and a second direction DR2 intersecting the first direction DR1. The substrate SUB may include a display area DA and a non-display area NDA. The non-display area NDA may be provided around at least a portion of the display area DA. The display area DA may be an area in which the pixels PXL are provided to display an image. The non-display area NDA may be an area at an edge of the display area DA.

The pixels PXL may be disposed in the display area DA of the substrate SUB. The pixels PXL may be disposed in a matrix form in the first direction DR1 and the second direction DR2 intersecting the first direction DR1. However, embodiments are not necessarily limited thereto. For example, the pixels PXL may be disposed in a zigzag shape in the first direction DR1 and the second direction DR2. For example, the pixels PXL may be arranged in a other shapes.

The pixels PXL may display a preset pattern and a reference image. The pixels PXL may include pixels of a first pixel group PXG1 and pixels of a second pixel group PXG2. Here, the first pixel group PXG1 may be disposed in odd-numbered pixel columns arranged in the second direction DR2, and the second pixel group PXG2 may be disposed in even-numbered pixel columns arranged in the second direction DR2. For example, a first pixel PXL1 included in the first pixel group PXG1 may display a left eye image. A second pixel PXL2 included in the second pixel group PXG2 may display a right eye image. The left eye image of the first pixel PXL1 may be viewed to a left eye of a user, and the right eye image of the second pixel PXL2 may be viewed to a right eye of the user.

Components for controlling the pixels PXL may be disposed in the non-display area NDA of the substrate SUB. For example, interconnects connected to the pixels PXL and pads connected to the interconnects may be disposed in the non-display area NDA. The pads may be disposed in the non-display areas NDA. The pads may be electrically connected to the pixels PXL through interconnects. For example, voltages and signals used for operating the pixels PXL may be provided through the interconnects and the pads.

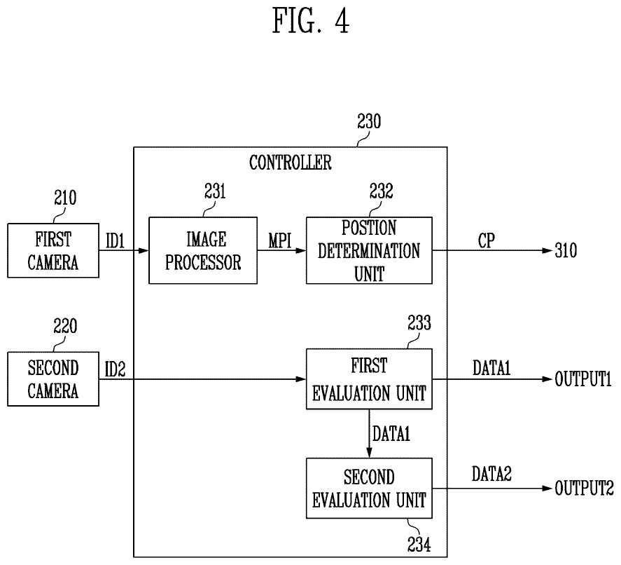

FIG. 4 is a block diagram illustrating an embodiment of a controller of the evaluation device of FIG. 2.

Referring to FIG. 2 and FIG. 4, an evaluation device ED may include a controller 230. The controller 230 may determine target measurement coordinates CP for at least one viewpoint and may evaluate crosstalk generated by a display device DD. The controller 230 may include an image processor 231, a position determination unit 232, a first evaluation unit 233, and a second evaluation unit 234.

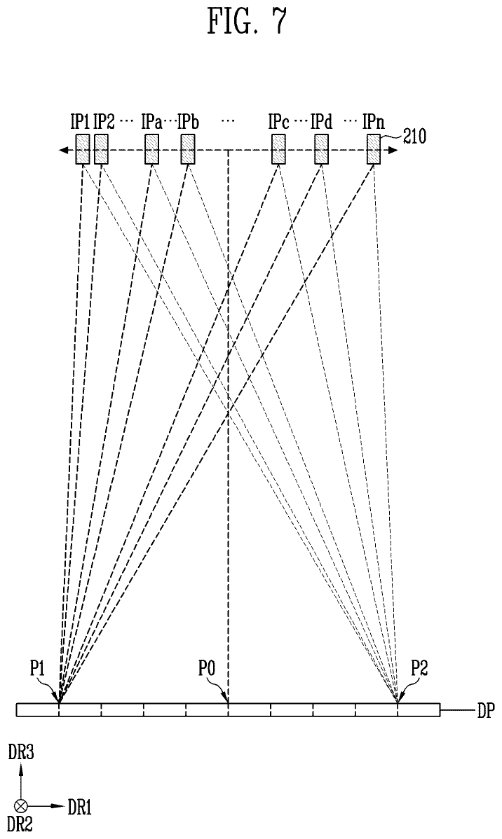

The controller 230 may receive first image data ID1 from a first camera 210. The first image data ID1 may be image data captured by the first camera 210. The first image data ID1 may be image data captured at first to n^{th} coordinates IP1 to IPn (see FIG. 7) arranged in a first direction DR1 by the first camera 210.

The image processor 231 may generate pattern measurement images MPI using the first image data ID1. The image processor 231 may generate pattern measurement images MPI in real time using the first image data ID1. The image processor 231 may generate the pattern measurement images MPI corresponding to each of coordinates arranged in the first direction DR1. For example, the image processor 231 may generate four pattern measurement images MPI corresponding to each of the first to nth coordinates IP1 to IPn (see FIG. 7). The image processor 231 may generate first and second pattern measurement images from the first image data ID1 obtained by photographing first and second patterns displayed at a first point P1 (see FIG. 7) of a display panel DP (see FIG. 7). The image processor 231 may generate third and fourth pattern measurement images from the first image data ID1 obtained by photographing third and fourth patterns displayed at a second point P2 (see FIG. 7) of the display panel DP.

The position determination unit 232 may determine measurement coordinates among the first to n^{th} coordinates IP1 to IPn. The position determination unit 232 may determine measurement coordinates among the first to n^{th} coordinates IP1 to IPn using luminance ratios of the pattern measurement images MPI. For example, the position determination unit 232 may determine first measurement coordinates at which a luminance ratio of the second pattern measurement image to the first pattern measurement image has a low value. For example, the position determination unit 232 may determine first measurement coordinates at which a luminance ratio of the second pattern measurement image to the first pattern measurement image is minimized. Herein, the “minimized” ratio or the ratio having a low value may be a ratio having value within about 5% or within about 10% of a minimum value over the determined luminance ratios. The position determination unit 232 may determine second measurement coordinates at which a luminance ratio of the fourth pattern measurement image to the third pattern measurement image is minimized. The position determination unit 232 may determine third measurement coordinates at which the luminance ratio of the first pattern measurement image to the second pattern measurement image is minimized. The position determination unit 232 may determine fourth measurement coordinates at which a luminance ratio of the third pattern measurement image to the fourth pattern measurement image is minimized.

The position determination unit 232 may determine a point as the target measurement coordinates CP. This point may be a point at which virtual lines extending from patterns to measurement coordinates overlap each other. For example, the position determination unit 232 may determine a point, at which a first virtual line extending from the first point P1 to the third measurement coordinates overlaps a second virtual line extending from the second point P2 to the fourth measurement coordinates, as the target measurement coordinates CP for a first point (for example, a left eye viewpoint). The position determination unit 232 may determine a point, at which a third virtual line extending from the first point P1 to the first measurement coordinates overlaps a fourth virtual line extending from the second point P2 to the second measurement coordinates, as the target measurement coordinates CP for a second point (for example, a right eye viewpoint).

The target measurement coordinates CP determined by the position determination unit 232 may be coordinates at which the luminance ratio has a low value for each viewpoint. For example, the low value may be a value approaching a minimum value, such as within about 1%, or within about 5%, or within about 10% of a minimum value over the viewpoints. These target measurement coordinates CP may transmitted to the first jig 310 to control the operation of the first jig 310. Therefore, the second camera 220 may be moved to the target measurement coordinates CP by the first jig 310.

The controller 230 may receive second image data ID2 from the second camera 220. The second image data ID2 may be image data (or luminance data) captured by the second camera 220. The second image data ID2 may be image data (or luminance data) captured by the second camera 220 at the target measurement coordinates CP.

The first evaluation unit 233 may generate first data DATA1 using the second image data ID2. For example, the first evaluation unit 233 may output the first data DATA1, which may be obtained by evaluating a crosstalk for a certain viewpoint using luminance values of reference images, in a two-dimensional (2D) format. However, the first data DATA1 is not necessarily limited thereto, and the first data DATA1 may quantify crosstalk in another manner.

According to an embodiment, the first evaluation unit 233 may generate the first data DATA1 using luminance values of first to third reference images captured by the second camera 220. For example, the first evaluation unit 233 may calculate a first corrected luminance value by subtracting a third luminance value measured from the third reference image from a first luminance value measured from the first reference image. The first evaluation unit 233 may calculate a second corrected luminance value by subtracting the third luminance value measured from the third reference image from a second luminance value measured from the second reference image. The first evaluation unit 233 may evaluate a crosstalk for a viewpoint with a ratio of the second correction luminance value to the first correction luminance value. Specifically, when a crosstalk for a left eye viewpoint is evaluated, the first reference image may be an image representing a left eye image having a reference luminance. The second reference image may be an image representing a right eye image having a reference luminance. The third reference image may be an image representing an image for correction. On the other hand, when a crosstalk for a right eye viewpoint is evaluated, the first reference image may be an image representing a right eye image having a reference luminance. The second reference image may be an image representing a left eye image having a reference luminance. The third reference image may be an image representing an image for correction.

The second evaluation unit 234 may generate second data DATA2 using the first data DATA1. For example, the second evaluation unit 234 may analyze a crosstalk to output the second data DATA2, which may be obtained by evaluating a uniformity of crosstalk for a viewpoint in a 2D format. The second data DATA2 may be data obtained by evaluating uniformity using at least one of an average value, a maximum value, a minimum value, or a relative standard deviation (RSD) value of a crosstalk. However, the second data DATA2 is not limited thereto as long as uniformity may be quantified.

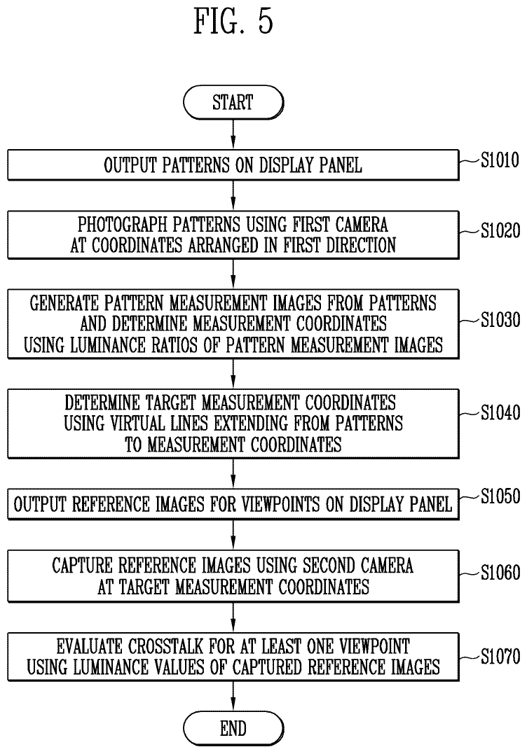

FIG. 5 is a flowchart illustrating a display device evaluation method according to an embodiment of the present invention.

Referring to FIG. 2 and FIG. 5, a display device evaluation method, which may evaluate the display device DD including the display panel DP (see FIG. 1) according to an embodiment, may include operation S1010 of outputting patterns on the display panel DP, operation S1020 of photographing the patterns using the first camera 210 at coordinates disposed along a first direction DR1, operation S1030 of generating pattern measurement images from the patterns and determining measurement coordinates using luminance ratios of the pattern measurement images, operation S1040 of determining target measurement coordinates using virtual lines extending from the patterns to the measurement coordinates, operation S1050 of outputting reference images for viewpoints on the display panel DP, operation S1060 of capturing the reference images using the second camera 220 at the target measurement coordinates, and operation S1070 of evaluating crosstalk for at least one viewpoint using luminance values of the captured reference images.

In a case that the evaluation device includes a camera configured to photograph the patterns and capture the reference images, in operation S1030, if a previous mode of the camera was set to capture the reference images a mode of the camera may be changed to photograph the patterns.

FIG. 6 is a view illustrating an example of patterns output on the display device of FIG. 3.

Referring to FIG. 5 and FIG. 6, in operation S1010, patterns for viewpoints may be output on the display panel DP as a displayed image. The pixels PXL (see FIG. 3) of the display panel DP may output first to fourth patterns PT1 to PT4.

The first and second patterns PT1 to PT2 may be displayed to overlap a first line LN1, wherein the first line LN1 may be spaced apart from a center point P0 of a reference line BLN in direction opposite to the first direction DR1. The third and fourth patterns PT3 to PT4 may be displayed to overlap a second line LN2, wherein the second line LN2 may be spaced apart from the center point P0 of the reference line BLN in the first direction DR1, wherein the reference line BLN extends in the first direction DR1 on the display panel DP. The first to fourth patterns PT1 to PT4 may be displayed adjacent to the reference line BLN.

For example, the first line LN1 may extend in a second direction DR2 and a direction opposite to the second direction DR2 from the first point P1 corresponding to 1/10 of a case where the reference line BLN is divided into ten equal parts in the first direction. The second line LN2 can extend in the second direction DR2 and the direction opposite to the second direction DR2 from a second point P2 corresponding to 9/10 of the case where the reference line BLN is divided into ten equal parts in the first direction DR1. However, embodiments are not necessarily limited thereto. For example, the first and second lines LN1 and LN2 may extend in the second direction DR2 and the direction opposite to the second direction DR2 from a point corresponding to ⅛ or ⅞ of the case where the reference line BLN is divided into eight equal parts in the first direction DR1.

The first and second patterns PT1 and PT2 may be displayed to overlap the first line LN1 extending from the first point P1. The first and second patterns PT1 and PT2 may face each other with the reference line BLN interposed therebetween. The first pattern PT1 may be spaced apart from the reference line BLN in the second direction DR2, and the second pattern PT2 may be spaced apart from the reference line BLN in the direction opposite to the second direction DR2. For example, the first pattern PT1 may be a right eye pattern for a right eye viewpoint, and the second pattern PT2 may be a left eye pattern for a left eye viewpoint.

The third and fourth patterns PT3 and PT4 may be displayed to overlap the second line LN2 extending from the second point P2. The third and fourth patterns PT3 and PT4 may face each other with the reference line BLN interposed therebetween. The third pattern PT3 may be spaced apart from the reference line BLN in the second direction DR2, and the fourth pattern PT4 may be spaced apart from the reference line BLN in the direction opposite to the second direction DR2. For example, the third pattern PT3 may be a right eye pattern for a right eye viewpoint, and the fourth pattern PT4 may be a left eye pattern for a left eye viewpoint.

FIG. 7 is a view illustrating an example in which the first camera of the evaluation device of FIG. 2 photographs patterns.

Referring to FIG. 2, FIG. 5, and FIG. 7, in operation S1020, the patterns may be photographed at the coordinates arranged in the first direction DR1 using the first camera 210.

First to n^{th} coordinates IP1 to IPn may be preset patterns to be photographed. Each of the first to n^{th} coordinates IP1 to IPn may be arranged in the first direction DR1 and preset at a position spaced apart from the display panel DP by a certain distance in a third direction DR3. For example, the first to b^{th} coordinates IP1 to IPb may be positioned in a direction opposite to the first direction DR1 with respect to the center point P0 of the display panel DP. Each of the first to b^{th} coordinates IP1 to IPb may be positioned at a left side of the center point P0 and may correspond to a left eye viewpoint. The c^{th} to n^{th} coordinates IPc to IPn may be positioned in the first direction DR1 with respect to the center point P0 of the display panel DP. Each of the c^{th} to n^{th} coordinates IPc to IPn may be positioned at a right side of the center point P0 and may correspond to a right eye viewpoint.

The first camera 210 may move relative to the display panel DP. The first camera 210 may move to each of the first to n^{th} coordinates IP1 to IPn in the first direction DR1. The first camera 210 may photograph the first to fourth patterns PT1 to PT4 (see FIG. 6) of the display panel DP at the first to n^{th} coordinates IP1 to IPn.

Referring to FIG. 6 and FIG. 7, the first camera 210 may photograph the first and second patterns PT1 and PT2 of the first point P1 at the first coordinates IP1. The first camera 210 may photograph the third and fourth patterns PT3 and PT4 of the second point P2 at the first coordinates IP1. The first camera 210 may move in the first direction DR1 to photograph the first and second patterns PT1 and PT2 of the first point P1 at the second coordinates IP2. The first camera 210 may photograph the third and fourth patterns PT3 and PT4 of the second point P2 at the second coordinates IP2. Thereafter, the first camera 210 may move in the first direction DR1 to photograph the first and second patterns PT1 and PT2 of the first point P1 and the third and fourth patterns PT3 and PT4 of the second point P2 at each of the a^{th} to n^{th} coordinates IPa to IPn.

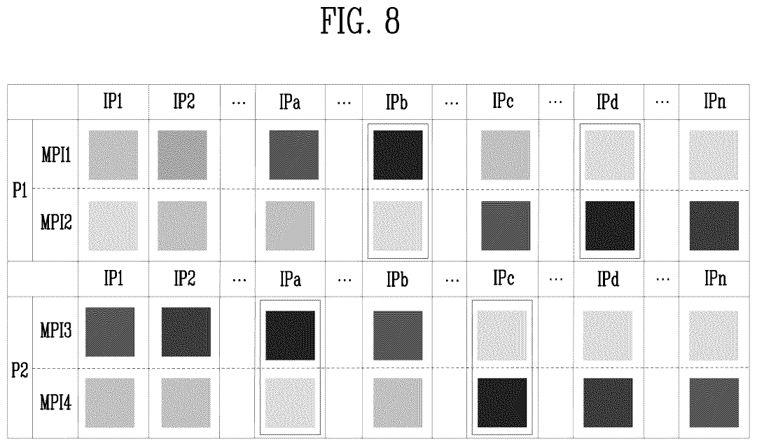

FIG. 8 is a view illustrating an example in which the controller of the evaluation device of FIG. 2 determines measurement coordinates from pattern measurement images.

Referring to FIG. 5, FIG. 7, and FIG. 8, in operation S1030, the patterns may be photographed to generate the pattern measurement images. The patterns may be photographed to generate the pattern measurement images in real time. First and second pattern measurement images MPI1 and MPI2 may be generated from the first and second patterns PT1 and PT2 (see FIG. 6) of the first point P1 photographed at the first to nth coordinates IP1 to IPn by the first camera 210. Third and fourth pattern measurement images MPI3 and MPI4 may be generated from the third and fourth patterns PT3 and PT4 (see FIG. 6) of the second point P2 at the first to nth coordinates IP1 to IPn photographed by the first camera 210. Accordingly, four pattern measurement images may be generated at each of the first to n^{th} coordinates IP1 to IPn.

Referring to FIG. 5 and FIG. 8, in operation S1030, the measurement coordinates may be determined using a luminance ratio of the pattern measurement image MPI2 to the pattern measurement image MPI1.

Measurement coordinates for determining the target measurement coordinates corresponding to a right eye viewpoint may be determined using the luminance ratio of the second pattern measurement image MPI2 to the first pattern measurement image MPI1 of the first point P1. The first measurement coordinates may be determined as the d^{th} coordinates IPd at which the luminance ratio of the second pattern measurement image MPI2 to the first pattern measurement image MPI1 may be at a low value, e.g., a minimum. For example, the d^{th} coordinates IPd may be coordinates at which the luminance of the first pattern measurement image MPI1 for a right eye pattern at the first point P1 is relatively higher than the luminance of the second pattern measurement image MPI2 for a left eye pattern. Accordingly, crosstalk for a right eye viewpoint with respect to the first point P1 may have a low value, e.g., a minimum value, at the d^{th} coordinates IPd.

Second measurement coordinates for determining the target measurement coordinates corresponding to a right eye viewpoint may be determined using a luminance ratio of the fourth pattern measurement image MPI4 to the third pattern measurement image MPI3 of the second point P2. The second measurement coordinates may be determined as the c^{th} coordinates IPc at which the luminance ratio of the fourth pattern measurement image MPI4 to the third pattern measurement image MPI3 may be at a low value, e.g., a minimum. For example, the c^{th} coordinates IPc may be coordinates at which the luminance of the third pattern measurement image MPI3 for a right eye pattern at the second point P2 is relatively higher than the luminance of the fourth pattern measurement image MPI4 for a left eye pattern. Accordingly, crosstalk for a right eye viewpoint with respect to the second point P2 may have a low value, e.g., a minimum value, at the c^{th} coordinates IPc.

Third measurement coordinates for determining the target measurement coordinates corresponding to a left eye viewpoint may be determined using a luminance ratio of the first pattern measurement image MPI1 to the second pattern measurement image MPI2 of the first point P1. The third measurement coordinates may be determined as the b^{th} coordinates IPb at which the luminance ratio of the first pattern measurement image MPI1 to the second pattern measurement image MPI2 may be at a low value, e.g., a minimum value. For example, the b^{th} coordinates IPb may be coordinates at which the luminance of the second pattern measurement image MPI2 for a left eye pattern at the first point P1 is relatively higher than the luminance of the first pattern measurement image MPI1 for a right eye pattern. Accordingly, crosstalk for a left eye viewpoint with respect to the first point P1 may have a low value, e.g., a minimum value, at the b^{th} coordinates IPb.

Fourth measurement coordinates for determining the target measurement coordinates corresponding to a left eye viewpoint may be determined using a luminance ratio of the third pattern measurement image MPI2 to the fourth pattern measurement image MPI4 of the second point P2. The fourth measurement coordinates may be determined as the a^{th} coordinates IPa at which the luminance ratio of the third pattern measurement image MPI3 to the fourth pattern measurement image MPI4 may be at a low value, e.g., a minimum value. For example, the a^{th} coordinates IPa may be coordinates at which the luminance of the fourth pattern measurement image MPI4 for a left eye pattern at the second point P2 is relatively higher than the luminance of the third pattern measurement image MPI3 for a right eye pattern. Accordingly, crosstalk for a left eye viewpoint with respect to the second point P2 may have a low value, e.g., a minimum value, at the a^{th} coordinates IPa.

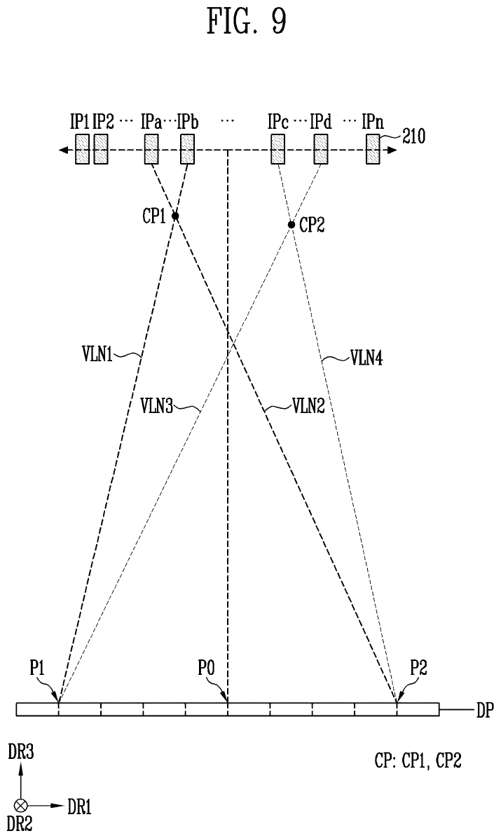

FIG. 9 is a view illustrating an example in which the controller of the evaluation device of FIG. 2 determines target measurement coordinates.

Referring to FIG. 5 and FIG. 9, in operation S1040, the target measurement coordinates may be determined. For example, the target measurement coordinates may be determined using the virtual lines extending from the patterns to the measurement coordinates.

The first target measurement coordinates CP1 corresponding to a left eye viewpoint may be determined as a point at which a first virtual line VLN1 and a second virtual line VLN2 overlap each other. For example, the controller 230 (see FIG. 4) may generate the first virtual line VLN1 extending from the first point P1 to the b^{th} coordinates IPb. The second virtual line VLN2 extending from the second point P2 to the a^{th} coordinates IPa may be generated. In addition, a point at which the first virtual line VLN1 and the second virtual line VLN2 overlap each other may be determined as the first target measurement coordinates CP1.

The second target measurement coordinates CP2 corresponding to a right eye viewpoint may be determined as a point at which a third virtual line VLN3 and a fourth virtual line VLN4 overlap each other. For example, the controller 230 may generate the third virtual line VLN3 extending from the first point P1 to the d^{th} coordinates IPd. The fourth virtual line VLN4 extending from the second point P2 to the c^{th} coordinates IPc may be generated. In addition, a point at which the third virtual line VLN3 and the fourth virtual line VLN4 overlap each other may be determined as the second target measurement coordinates CP2.

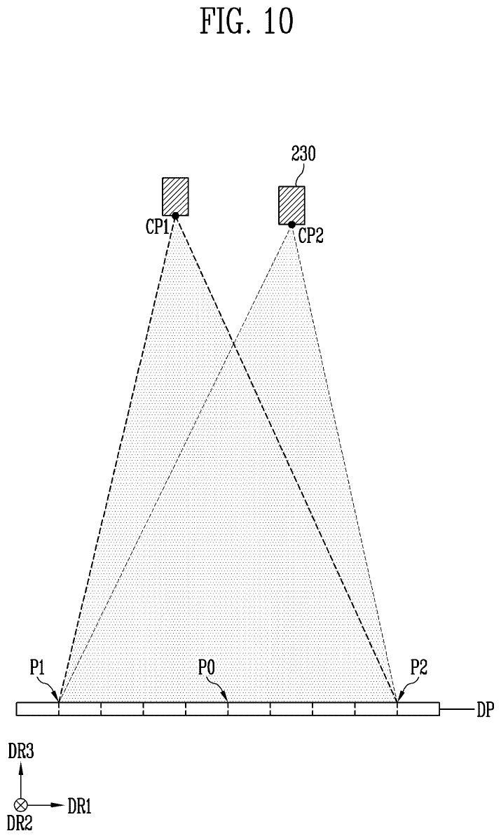

FIG. 10 is a view illustrating an example in which the second camera of the evaluation device of FIG. 2 captures reference images.

Referring to FIG. 5 and FIG. 10, in operation S1050, the reference images for the viewpoints may be output on the display panel DP. The pixels PXL (see FIG. 3) of the display panel DP may output first to third reference images.

According to an embodiment, the first to third reference images may be displayed through the first and second pixel groups PXG1 and PXG2 (see FIG. 3). For example, the first reference image may display a white gradation through the first pixel group PXG1 and a dark, e.g., black, gradation through the second pixel group PXG2. The first reference image may be a left eye image corresponding to a left eye viewpoint. The second reference image may display a black gradation through the first pixel group PXG1 and a light, e.g., white, gradation through the second pixel group PXG2. The second reference image may be a right eye image corresponding to a right eye viewpoint. The third reference image may display a black gradation through the first and second pixel groups PXG1 and PXG2. The third reference image may be a compensation image that compensates for errors caused by other factors (for example, ambient light).

Referring to FIG. 5 and FIG. 10, in operation S1060, the reference images may be captured at the target measurement coordinates using the second camera 220.

According to an embodiment, the second camera 220 may move relative to the display panel DP. The second camera 220 may move from any one of the first to n^{th} coordinates IP1 to IPn to the first target measurement coordinates CP1. The second camera 220 may capture the first to third reference images of the display panel DP at the first target measurement coordinates CP1 at which a crosstalk for a left eye viewpoint has a low value, e.g., a minimum value. According to another embodiment, the second camera 220 may move from any one of the first to n^{th} coordinates IP1 to IPn to the second target measurement coordinates CP2. The second camera 220 may capture first to third reference images of the display panel DP at the second target measurement coordinates CP2 at which a crosstalk for a right eye viewpoint has a low value, e.g., a minimum value.

In addition, the second camera 220 may measure luminances of reference images captured in real time. For example, the second camera 220 may measure the luminances of the first to third reference images for the first and second target measurement coordinates CP1 and CP2. Specifically, the second camera 220 may measure a luminance value corresponding to each pixel PXL in the first to third reference images.

In a case that the evaluation device includes a camera configured to photograph the patterns and capture the reference images, in operation S1060, a mode of the camera may be changed to capture the reference images.

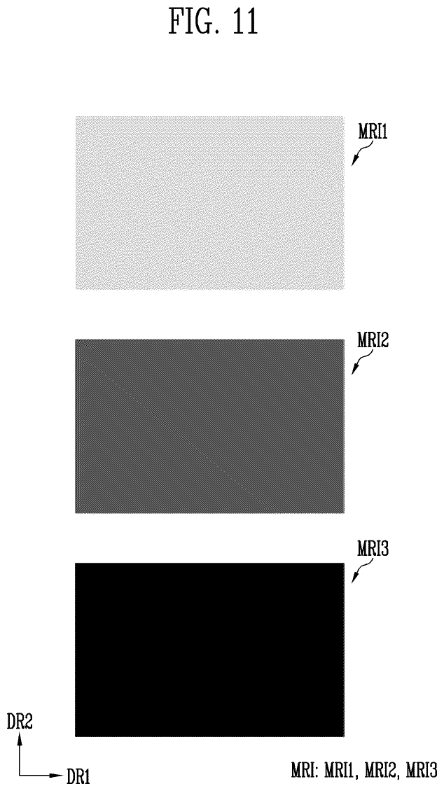

FIG. 11 is a view illustrating an example of the reference images captured in FIG. 10.

Referring to FIG. 5 and FIG. 11, in operation S1070, the crosstalk for at least one viewpoint may be evaluated using the luminance values of the captured reference images. In operation S1070, the crosstalk for each viewpoint may be evaluated using the luminance values of the captured reference images. Hereinafter, for clear description, the first to third reference images MIR1 to MIR3 captured at the first target measurement coordinates CP1 corresponding to a left eye viewpoint may be illustrated as examples.

A crosstalk for a left eye viewpoint may be evaluated using luminance values of the first to third reference images MIR1 to MIR3 captured at the first target measurement coordinates CP1 corresponding to a left eye viewpoint. According to an embodiment, a crosstalk may be evaluated using a first luminance value measured from the first reference image MRI1, a second luminance value measured from the second reference image MRI2, and a third luminance value measured from the third reference image MRI3.

For example, the controller 230 may calculate a first corrected luminance value by subtracting the third luminance value measured from the third reference image MRI3 from the first luminance value measured from the first reference image MRI1. A second corrected luminance value may be calculated by subtracting the third luminance value measured from the third reference image MRI3 from the second luminance value measured from the second reference image MRI2. A crosstalk for a left eye viewpoint may be evaluated as a ratio of the second corrected luminance value to the first corrected luminance value. However, embodiments are not necessarily limited thereto. For example, when luminance values measured at target measurement coordinates are used, a crosstalk may be evaluated by applying a known crosstalk analysis algorithm.

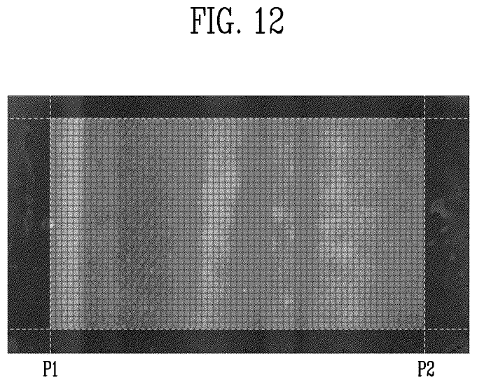

FIG. 12 is a view illustrating an example of a crosstalk evaluated by the evaluation device of FIG. 2.

Referring to FIG. 12, the evaluation device ED may evaluate and output a crosstalk for at least one viewpoint. For example, the evaluation device ED may output a crosstalk evaluated at the first target measurement coordinates CP1 (see FIG. 10) corresponding to a left eye viewpoint or a crosstalk evaluated at the second target measurement coordinates CP2 (see FIG. 10) corresponding to a right eye viewpoint as data in a 2D data form. As shown in FIG. 12, the data in a 2D form may be displayed to be distinguished by a color according to a size of a crosstalk evaluated for each pixel PXL.

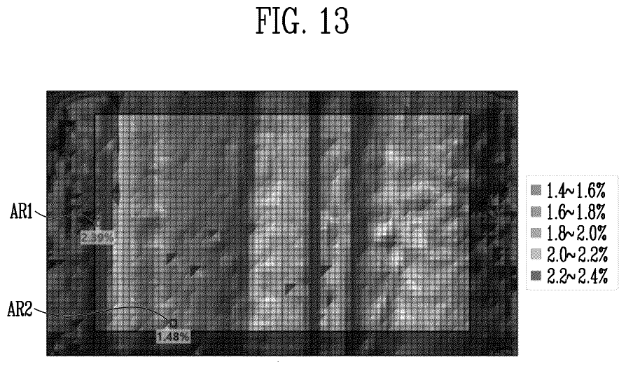

FIG. 13 is a view illustrating an example of uniformity analyzed using the crosstalk of FIG. 12.

Referring to FIG. 13, the evaluation device ED may output a value for a uniformity of crosstalk for at least one viewpoint. For example, the evaluation device ED may analyze crosstalk and output uniformity as data in a 2D form.

In an embodiment, a crosstalk in a first region AR1 may have a high value, e.g., a maximum value, and a crosstalk in a second region AR2 may have a low value, e.g., a minimum value. For example, the first region AR1 may include a pixel with coordinates (1, 18) in the data in the 2D form. A value obtained by converting a size of the crosstalk in the first region AR1 into a numerical value may be about 2.39%. The second region AR2 may include a pixel with coordinates (14, 2) in the data in the 2D form. A value obtained by converting a size of the crosstalk in the second region AR2 into a numerical value may be about 1.48%. An average value by converting the size of the crosstalk into a numerical value in the data in the 2D form in FIG. 13 may be about 2.78%, and a standard deviation value may be about 10.0%. However, embodiments are not necessarily limited thereto, and the uniformity of crosstalk may be evaluated by applying a known method.

In this way, by analyzing the uniformity using at least one of an average value, a maximum value, a minimum value, and an RSD value of a crosstalk in data in a 2D form, the evaluation device ED may more effectively evaluate a degree of crosstalk of the display device DD.

In an evaluation device for evaluating a display device that displays images for viewpoints according to embodiments of the present invention, the accuracy of evaluation may be improved by determining target measurement coordinates corresponding to a left eye viewpoint and a right eye viewpoint in advance and evaluating crosstalk of the display device at the determined target measurement coordinates. In addition, an evaluation device may shorten an evaluation time of a crosstalk by measuring a luminance value for a number of shots corresponding to target measurement coordinates, which may be, a reduced number of shots. For example, a minimum number of shots may be determined corresponding to the number of target measurement coordinates. As described herein, the target measurement coordinates CP may be determined by the position determination unit 232 to be coordinates at which a crosstalk has a minimum value for each viewpoint.

According to embodiments of the present invention, there are provided an evaluation device having improved accuracy and a display device evaluation method using the same.

The effects according to embodiments are not limited to the contents exemplified above, and more various effects are included in the present specification.

Although specific embodiments and applications have been described herein, other embodiments and modifications may be derived from the above description. Accordingly, the inventive invention is not limited to such embodiments, but rather to the broader scope of the presented claims and various obvious modifications and equivalent arrangements.

What is claimed is:

1. An evaluation device for evaluating a display device which displays images for viewpoints through a display panel, the evaluation device comprising:
a first camera configured to photograph patterns for the viewpoints displayed by the display panel at coordinates arranged in a first direction;
a second camera configured to capture reference images for the viewpoints displayed by the display panel at target measurement coordinates; and
a controller configured to generate pattern measurement images from the patterns photographed by the first camera, determine the target measurement coordinates using luminance ratios of the pattern measurement images, and evaluate crosstalk for at least one viewpoint of the viewpoints using luminance values of the reference images captured at the target measurement coordinates by the second camera.

2. The evaluation device of claim 1, further comprising:
a first jig configured to support the first camera and the second camera; and
a second jig configured to support the display device,
wherein the first camera is provided to move in the first direction and a direction opposite to the first direction relative to the second jig, and
the second camera is provided to move in the first direction, the direction opposite to the first direction, a third direction perpendicular to the first direction, and a direction opposite to the third direction relative to the second jig.

3. The evaluation device of claim 2, wherein the first jig is configured to move the first camera and the second camera in the first direction, the direction opposite to the first direction, the third direction, and the direction opposite to the third direction.

4. The evaluation device of claim 2, wherein the second jig is configured to move the display device in the first direction and the direction opposite to the first direction.

5. The evaluation device of claim 1, wherein the patterns are displayed to overlap a first line spaced apart from a center point of a reference line in a direction opposite to the first direction and a second line spaced apart from the center point in the first direction, wherein the reference line extends in the first direction on the display panel.

6. The evaluation device of claim 5,
wherein the first line and the second line extend in a second direction intersecting the first direction and a direction opposite to the second direction from a first point corresponding to 1/10 and a second point corresponding to 9/10 when the reference line is divided into ten equal parts in the first direction,
wherein the patterns include a first pattern and a second pattern displayed to overlap the first line and a third pattern and a fourth pattern displayed to overlap the second line,
wherein the first pattern and the second pattern face each other with the reference line interposed therebetween, and
the third pattern and the fourth pattern face each other with the reference line interposed therebetween.

7. The evaluation device of claim 6, wherein the patterns are positioned adjacent to the reference line,
the first pattern and the third pattern are spaced apart from the reference line in a second direction, and
the second pattern and the fourth pattern are spaced apart from the reference line in the direction opposite to the second direction.

8. The evaluation device of claim 6, wherein the pattern measurement images include a first pattern measurement image and a second pattern measurement image generated from the first pattern and the second pattern, and a third pattern measurement image and a fourth pattern measurement image generated from the third pattern and fourth pattern, and
the controller determines first measurement coordinates at which a luminance ratio of the second pattern measurement image to the first pattern measurement image is a low value, second measurement coordinates at which a luminance ratio of the fourth pattern measurement image to the third pattern measurement image is a low value, third measurement coordinates at which a luminance ratio of the first pattern measurement image to the second pattern measurement image is a low value, and fourth measurement coordinates at which a luminance ratio of the third pattern measurement image to the fourth pattern measurement image is a low value.

9. The evaluation device of claim 8, wherein the controller determines a point, at which a first virtual line extending from the first point to the third measurement coordinates overlaps a second virtual line extending from the second point to the fourth measurement coordinates, as the target measurement coordinates for a first viewpoint of the viewpoints.

10. The evaluation device of claim 8, wherein the controller determines a point, at which a third virtual line extending from the first point to the first measurement coordinates overlaps a fourth virtual line extending from the second point to the second measurement coordinates, as the target measurement coordinates for a second viewpoint of the viewpoints.

11. The evaluation device of claim 1, wherein the display panel includes pixels,
the pixels include a first pixel group of the display device configured to display a stereoscopic image and a second pixel group configured to display the stereoscopic image, and
the reference images are displayed through the first pixel group and the second pixel group.

12. The evaluation device of claim 11, wherein the reference images include a first reference image corresponding to a first viewpoint of the viewpoints, a second reference image corresponding to a second viewpoint of the viewpoints, and a third reference image commonly corresponding to the first viewpoint and the second viewpoint,
the first reference image is configured to display a white gradation through the first pixel group and a black gradation through the second pixel group,
the second reference image is configured to display the black gradation through the first pixel group and the white gradation through the second pixel group, and
the third reference image is configured to display the black gradation through the first pixel group and the second pixel group.

13. The evaluation device of claim 12, wherein the controller calculates a first corrected luminance value by subtracting a third luminance value measured from the third reference image from a first luminance value measured from the first reference image, and a second corrected luminance value by subtracting the third luminance value measured from the third reference image from a second luminance value measured from the second reference image, and
the controller evaluates the crosstalk for the first viewpoint using a ratio of the second corrected luminance value to the first corrected luminance value.

14. The evaluation device of claim 1, wherein the controller is configured to evaluate uniformity for the at least one viewpoint.

15. An evaluation device for evaluating a display device which displays images for viewpoints through a display panel, the evaluation device comprising:
a camera having a first mode configured to photograph patterns for the viewpoints displayed by the display panel at coordinates arranged in a first direction and a second mode configured to capture reference images for the viewpoints displayed by the display panel at target measurement coordinates; and
a controller configured to generate pattern measurement images from the patterns photographed by the camera in the first mode, determine the target measurement coordinates using luminance ratios of the pattern measurement images, and evaluate crosstalk for at least one viewpoint of the viewpoints using luminance values of the reference images captured at the target measurement coordinates by the camera in the second mode.

16. A display device evaluation method of evaluating a display device including a display panel, the display device evaluation method comprising:
displaying, by the display panel, patterns for viewpoints;
photographing the patterns at coordinates disposed along a first direction;
determining target measurement coordinates for at least one viewpoint of the viewpoints based on the patterns;
outputting reference images for the viewpoints;
capturing the reference images at the target measurement coordinates; and
evaluating a crosstalk for the at least one viewpoint using luminance values of the reference images.

17. The display device evaluation method of claim 16, wherein the determining of the target measurement coordinates includes:
generating pattern measurement images from the patterns and determining measurement coordinates using luminance ratios of the pattern measurement images; and
determining the target measurement coordinates using virtual lines extending from the patterns to the measurement coordinates.

18. The display device evaluation method of claim 16, wherein the target measurement coordinates are coordinates at which crosstalk for at least one viewpoint of the viewpoints has a minimum value.

19. The display device evaluation method of claim 16, wherein the photographing of the patterns is performed using a first camera, and
the capturing of the reference images is performed using a second camera.

20. The display device evaluation method of claim 17, wherein determining the target measurement coordinates for the at least one viewpoint of the viewpoints based on the patterns comprises determining a number of the target measurement coordinates to be determined using luminance ratios of the pattern measurement images.
